(19) United States
(12) Patent Application Publication
(10) Pub. No.: US 2014/0016223 A1
(43) Pub. Date: Jan. 16, 2014

(54) MAGNETIC DISK DEVICE, MAGNETIC DISK CONTROLLING APPARATUS, AND HEAD POSITION DETERMINING METHOD

(71) Applicant: KABUSHIKI KAISHA TOSHIBA, Tokyo (JP)

(72) Inventors: Kazumasa NOMURA, Tokyo (JP); Kenji YOSHIDA, Kanagawa (JP); Satoshi SHIBATA, Tokyo (JP)

(73) Assignee: KABUSHIKI KAISHA TOSHIBA, Tokyo (JP)

(21) Appl. No.: 13/671,102

(22) Filed: Nov. 7, 2012

(30) Foreign Application Priority Data
Jul. 12, 2012 (JP) 2012-156482

(51) Int. Cl. G11B 5/09

(52) U.S. Cl. 360/48; G9B/5.033

(57) ABSTRACT

According to one embodiment, a magnetic disk device includes an initial calculation module and a simple determination module. The initial calculation module, in a simple determination expression describing a magnitude relation between a first value calculated from a first half part of the burst data and a second value calculated from a second half part of the burst data, starts a calculation of the first value before the reading of the second half part of the burst data is completed. The simple determination module performs a determination by the simple determination expression after the reading of the second half part of the burst data is completed.

### CROSS-REFERENCE TO RELATED APPLICATIONS

This application is based upon and claims the benefit of priority from Japanese Patent Application No. 2012-156482, filed on Jul. 12, 2012; the entire contents of which are incorporated herein by reference.

### FIELD

Embodiments described herein relate generally to a magnetic disk device, a magnetic disk controlling apparatus, and a head position determining method.

### BACKGROUND

A magnetic disk device performs a load of burst data representing position information on a track, together with a sector/cylinder number within servo data, and performs a head position determination, based on the information. Since a head position determination operation is started after the load of all burst data is completed, a time to calculate from the end of a servo area on media is required. In the case in which it takes a long time to calculate from the end of the servo area, if a data write is performed in an off-track state, there is a high risk of damaging data of adjacent tracks.

### BRIEF DESCRIPTION OF THE DRAWINGS

FIG. 1 is a block diagram illustrating a schematic configuration of a magnetic disk device according to a first embodiment;

FIG. 2A is a plan view illustrating a track arrangement in a magnetic disk of FIG. 1, and FIG. 2B is a diagram illustrating a configuration example of a servo area of FIG. 2A;

FIG. 3 is a diagram illustrating a magnitude relation of arithmetic expressions f1 and f2 according to read levels of burst data A, B, C and D of FIG. 2B;

FIG. 4 is a flow chart illustrating a head position determining method in the magnetic disk device of FIG. 1;

FIG. 5 is a block diagram illustrating a schematic configuration of a magnetic disk device according to a second embodiment;

FIG. 6 is a flow chart illustrating a head position determining method in the magnetic disk device of FIG. 5; and

FIG. 7 is a diagram illustrating inhibit determination ranges R1 and R2 and wait determination ranges R3 and R4 according to read levels of burst data A, B, C and D of FIG. 2B.

### DETAILED DESCRIPTION

In general, according to one embodiment, a magnetic disk device includes an initial calculation module and a simple determination module. The initial calculation module, in a simple determination expression describing a magnitude relation between a first value calculated from a first half part of the burst data and a second value calculated from a second half part of the burst data, starts a calculation of the first value before the reading of the second half part of the burst data is completed. The simple determination module performs a determination by the simple determination expression after the reading of the second half part of the burst data is completed.

Hereinafter, magnetic disk devices according to embodiments will be described in detail with reference to the accompanying drawings. Also, the present invention is not limited to these embodiments.

### First Embodiment

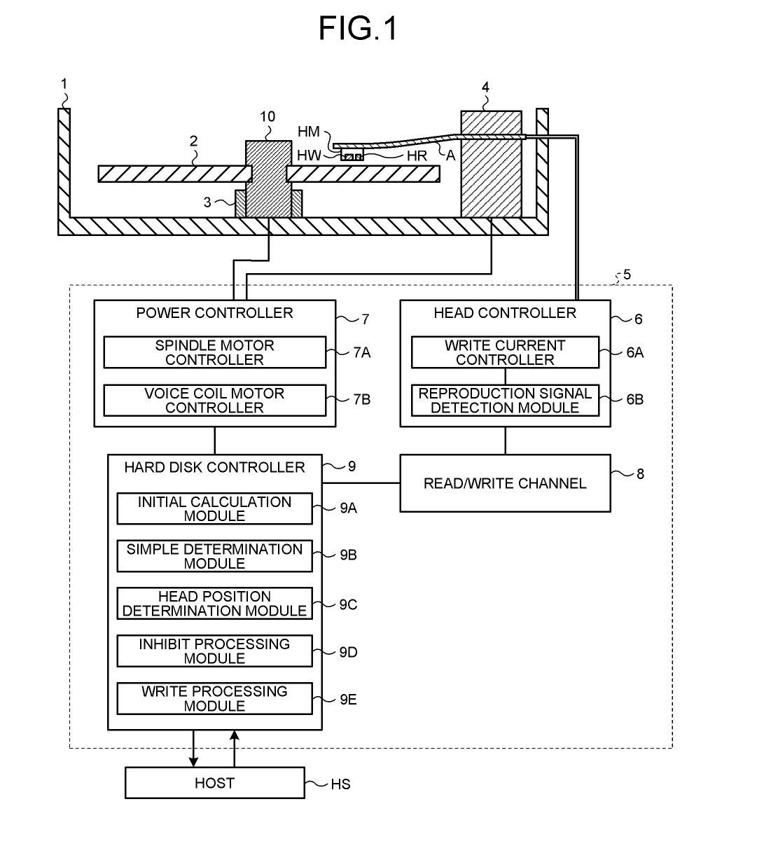

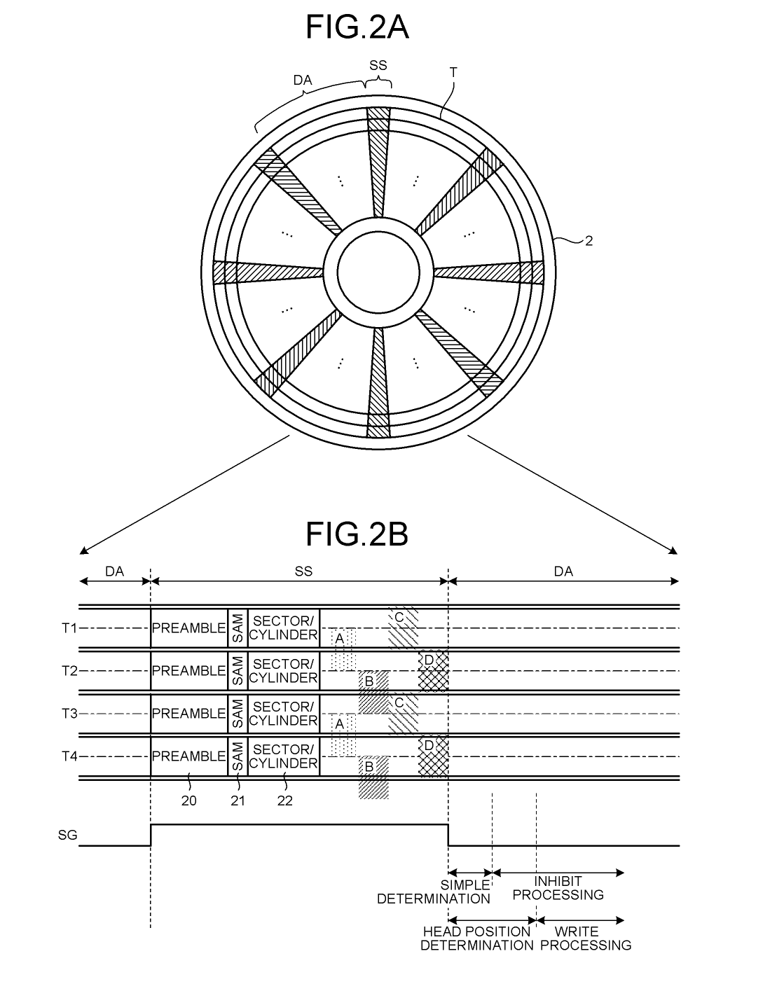

FIG. 1 is a block diagram illustrating a schematic configuration of a magnetic disk device according to a first embodiment, FIG. 2A is a plan view illustrating a track arrangement in a magnetic disk 2 of FIG. 1, and FIG. 2B is a diagram illustrating a configuration example of a servo area of FIG. 2A.

In FIG. 1, in the magnetic disk device, the magnetic disk 2 is provided, and the magnetic disk 2 is supported through a spindle 10. Also, a magnetic head HM is provided in the magnetic disk device, a write head HW and a read head HR are provided in the magnetic head HM. The write head HW and the read head HR are arranged to face the magnetic disk 2. The magnetic head HM is held on the magnetic disk 2 through an arm A. The arm A may allow the magnetic head HM to slide in a horizontal plane.

Herein, as illustrated in FIG. 2A, tracks T are provided on the magnetic disk 2 along a circumferential direction. In the respective tracks T, data areas DA, in which user data is to be written, and servo areas SS, in which servo data is written, are provided. Herein, the servo areas SS are radially arranged, and the data areas DA are arranged between the servo areas SS. In the servo area SS, as illustrated in FIG. 2B, a preamble 20, a servo area mark 21, sector/cylinder information 22, and burst data A, B, C and D are written. Also, the sector/cylinder information 22 may be assigned with servo addresses of a circumferential direction and a radial direction of the magnetic disk 2, and may be used for a seek control that moves the magnetic head HM to a target track. The burst data A, B, C and D may be used for a tracking control that determines a position of the magnetic head HM within the range of the target track.

Herein, the burst data A and B may be used for a center determination of the track T, and the burst data C and D may be used for an even/odd determination of the track T. The burst data A and B may be arranged in the first half part of the burst data A, B, C and D, and the burst data C and D may be arranged in the second half part of the burst data A, B, C and D. Also, for example, in the tracks T1 to T4 adjacent to each other, the burst data A and B may be arranged across the boundaries of the tracks T1 to T4, and the burst data C and D may be arranged across the center lines of the tracks T1 to T4. In this case, the burst data A may be arranged at the odd-numbered boundaries among the boundaries of the tracks T1 to T4, and the burst data B may be arranged at the even-numbered boundaries among the boundaries of the tracks T1 to T4. The burst data C may be arranged at the odd-numbered tracks T1 and T3 among the tracks T1 to T4, and the burst data D may be arranged at the even-numbered tracks T2 and T4 among the tracks T1 to T4.

Also, in the magnetic disk device, a voice coil motor 4 driving the arm A is provided, and a spindle motor 3 rotating the magnetic disk 2 through the spindle 10 is provided. The magnetic disk 2, the magnetic head HM, the arm A, the voice coil motor 4, the spindle motor 3, and the spindle 10 are accommodated in a case 1.

Also, a magnetic recording controller 5 is provided in the magnetic disk device. A head controller 6, a power controller 7, a read/write channel 8, and a hard disk controller 9 are provided in the magnetic recording controller 5. In the head controller 6, a write current controller 6A and a reproduction signal detection module 6B are provided. In the power controller 7, a spindle motor controller 7A and a voice coil motor controller 7B are provided. In the hard disk controller 9, an initial calculation module 9A, a simple determination module 9B, a head position determination module 9C, an inhibit processing module 9D, and a write processing module 9E are provided.

The head controller 6 may amplify or detect a signal at the time of recording and reproduction. The write current controller 6A may control a write current flowing through the write head HW. The reproduction signal detection module 6B may detect a signal read by the read head HR.

The power controller 7 may drive the voice coil motor 4 and the spindle motor 3. The spindle motor controller 7A may control the rotation of the spindle motor 3. The voice coil motor controller 7B may control the driving of the voice coil motor 4.

The read/write channel 8 may perform data exchange between the head controller 6 and the hard disk controller 9. Also, examples of the data may include read data, write data, and servo data. For example, the read/write channel 8 may convert a signal reproduced by the read head HR into a data format treated in a host HS, or may convert data output from the host HS into a signal format recorded by the write head HW. Examples of such a format conversion may include a DA conversion or an encoding. Also, the read/write channel 8 may perform a process of decoding the signal reproduced by the read head HR, or may perform a code modulation on data output from the host HS.

The hard disk controller 9 may perform a recording/reproduction control, based on an instruction from the host HS, or may perform data exchange between the host HS and the read/write channel 8. In a simple determination expression describing a magnitude relation between a first value calculated from the burst data A and B and a second value calculated from the burst data C and D, the initial calculation module 9A may start the calculation of the first value before the reading of the burst data C and D is completed. The simple determination module 9B may make a determination by the simple determination expression after the reading of the burst data C and D is completed. Also, in the simple determination expression, it may be determined whether the position of the magnetic head HM to the target track is always outside an upper/lower limit range. The head position determination module 9C may determine the position of the magnetic head HM, based on a head position determination expression calculated from the burst data A, B, C and D. The inhibit processing module 9D may perform an inhibit (error condition) processing when satisfying the condition of the simple determination expression. In the inhibit processing, an inhibit signal is generated to inhibit a write in the data area DA subsequent to the servo area SS. The write processing module 9E may perform a write processing, based on the calculation result of the head position determination expression, when not satisfying the condition of the simple determination expression.

Also, in the head position determination expression, a position error amount PES of the magnetic head HM with respect to the target track may be determined. The head position determination expression may be given by Equation (1) below.

PES=(A−B)/(IA−BI+IC−DI)+((A−B)*|A−B|)/(|A−B|ⁿ+|C−D|ⁿ) (1)

It is preferable that n be set in a range from 1.2 to 2.

Also, in the simple determination expression, it may be determined whether the position error amount PES of the magnetic head HM with respect to the target track always satisfies an upper/lower limit condition. The simple determination expression may be given by Equation (2) or (3) below, when it is assumed that LL is a lower limit, ML is an upper limit, and n is 2.

|C−D|≧(A−B)*2/LL−|A−B| and

|C−D|²≦(A−B)*|A−B|*2/ML−|A−B|² (2),

or

|C−D|²≧(A−B)*|A−B|*2/LL−|A−B|² and

|C−D|≦(A−B)*2/ML−|A−B|² (3)

The magnetic recording controller 5 is connected to the host HS. Also, the host HS may be a personal computer that issues a write command or a read command to the magnetic disk device, or may be an external interface.

While the magnetic disk 2 is rotated by the spindle 10, a signal is read from the magnetic disk 2 through the read head HR and is detected by the reproduction signal detection module 6B. The signal detected by the reproduction signal detection module 6B is data-converted in the read/write channel 8 and is then transferred to the hard disk controller 9. In the hard disk controller 9, a tracking control of the magnetic head 2 is performed based on the burst data A, B, C and D included in the signal detected by the reproduction signal detection module 6B.

In this case, when a servo gate SG rises up, the burst data A, B, C and D are read from the servo area SS in order of A→B→C→D. When the burst data A and B are read, the right-hand sides of Equations (2) and (3) are calculated in the initial calculation module 9A. Since the burst data C and D are not included in the right-hand sides of Equations (2) and (3), the calculation of the right-hand sides of Equations (2) and (3) may be started before the reading of the burst data C and D is completed. When the reading of the burst data C and D is completed, the determination of Equations (2) and (3) is made in the simple determination module 9B. When satisfying the condition of Equation (2) or (3), the inhibit processing is performed in the inhibit processing module 9D.

On the other hand, when the reading of the burst data A, B, C and D is completed, the position error amount PES is calculated from Equation (1) in the head position determination module 9C. When the position error amount PES satisfies the upper/lower limit condition, the write processing is performed in the write processing module 9E. In the write processing, the current of the write head HW is controlled through the write current controller 6A, and user data is written to the data area DA of the magnetic disk 2.

Herein, since the calculation of the right-hand sides of Equations (2) and (3) may be started before the reading of the burst data C and D is completed, the determination of Equations (2) and (3) may be completed before the calculation of Equation (1) is completed. Therefore, compared with the method of making the head position determination using Equation (1), the inhibit processing may be early started. Thus, data loss caused by write error may be prevented, and high speed processing may be achieved.

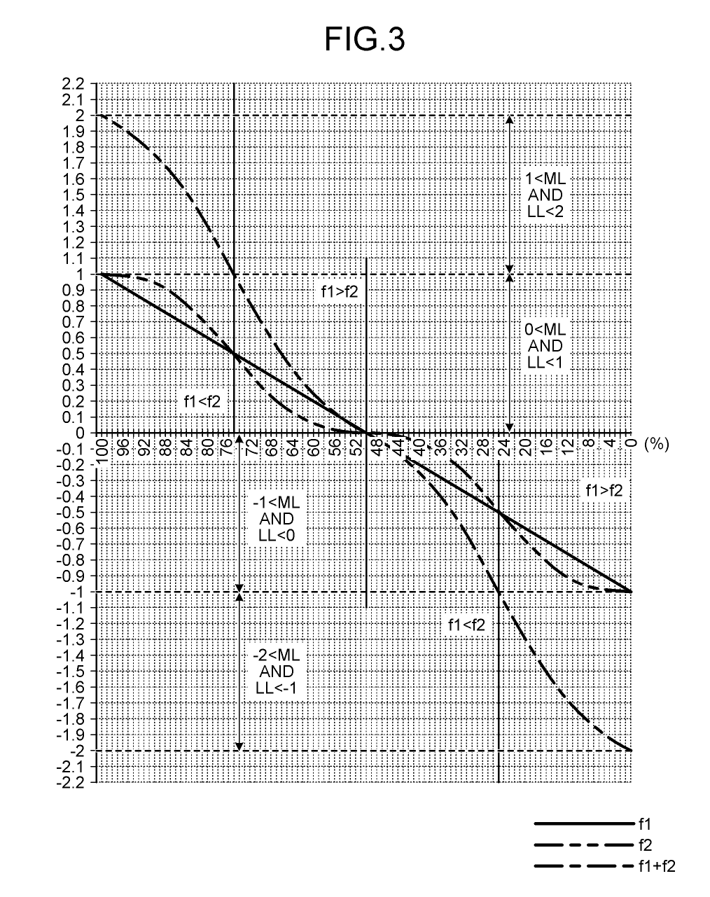

FIG. 3 is a diagram illustrating a magnitude relation of arithmetic expressions f1 and f2 according to read levels of the burst data A, B, C and D in FIG. 2B. Herein, a horizontal axis represents a variation in a ratio of the burst data A, B, C and D. That is, the horizontal axis represents a ratio (%) of A to A+B and a ratio (%) of C to C+D.

In FIG. 3, when it is assumed that the first-order equation part of Equation (1) is f1 and the second-order equation part of Equation (1) is f2, Equation (1) may be given by Equation (4) below. Herein, n=2.

PES=f1+f2 (4)

where,

f1=(A−B)/(|A−B|+|C−D|) (5)

f2=((A−B)*|A−B|)/(|A−B|²+|C−D|²) (6)

As can be seen from FIG. 3, in the range of 0<ML and LL<1 or in the range of −2<ML and LL<−1, f1>f2. A maximum/minimum range of the head position determination expression of Equation (4) may be given by Equation (7) below.

2*f2<(f1+f2)<2*f1 (7)

In the case in which the lower limit LL is greater than the maximum value=2*f1 in Equation (5), or in the case where the upper limit ML is less than the minimum value=2*f2 in Equation (5), the upper/lower limit condition in the head position determination expression in Equation (4) is not satisfied, and it may be always determined as inhibit.

The condition at this time may be given by Equations (8) and (9) below.

f1+f2<2*f1≦LL→f1≦LL/2 (8)

f1+f2>2*f2≧ML→f2≧ML/2 (9)

By applying Equations (5) and (6) to Equations (8) and (9), the condition of Equation (2) may be derived.

That is, as described below, a first equation of Equation (2) may be obtained by applying Equations (5) and (6) to Equation (8), collecting C and D on the left-hand side, and collecting A and B on the right-hand side.

LL/2≧f1=(A−B)/(|(A−B)|+|(C−D)|)

LL/2*|(A−B)|+LL/2*|(C−D)|≧(A−B)

|C−D|≧(A−B)*2/LL−|A−B|

Also, as described below, a second equation of Equation (2) may be obtained by applying Equations (5) and (6) to Equation (9), collecting C and D on the left-hand side, and collecting A and B on the right-hand side.

ML/2≦f2=(A−B)*|(A−B)|/(|(A−B)|²+|(C−D)|²

ML/2*|(A−B)|²+ML/2*|(C−D)|²≦(A−B)*|(A−B)|

|(C−D)|²≦(A−B)*|(A−B)|²/ML−|(A−B)|²

In a similar manner, in the range of 1<ML and LL<2 or in the range of −1<ML and LL<0, f1<f2. A maximum/minimum range of the head position determination expression in Equation (4) may be given by Equation (10) below.

2*f1<(f1+f2)<2*f2 (10)

In the case in which the lower limit LL is greater than the maximum value=2*f2 in Equation (10), or in the case where the upper limit ML is less than the minimum value=2*f1 in Equation (10), the upper/lower limit condition in the head position determination expression in Equation (4) is not satisfied, and it may be always determined as inhibit.

The condition at this time may be given by Equations (11) and (12) below.

f1+f2<2*f2≦LL→f2≦LL/2 (11)

f1+f2>2*f1≧ML→f1≧ML/2 (12)

By applying Equations (5) and (6) to Equations (11) and (12), the condition of Equation (3) may be derived.

That is, as described below, a first equation of Equation (3) may be obtained by applying Equations (5) and (6) to Equation (11), collecting C and D on the left-hand side, and collecting A and B on the right-hand side.

LL/2≧f2=(A−B)*|(A−B)|/(|(A−B)|²+|(C−D)|²)

LL/2*|(A−B)|²+LL/2*|(C−D)|²≧(A−B)*|(A−B)|

|(C−D)|²≧(A−B)*|(A−B)|²/LL−|(A−B)|²

Also, as described below, a second equation in Equation (3) may be obtained by applying Equations (5) and (6) to Equation (12), collecting C and D on the left-hand side, and collecting A and B on the right-hand side.

ML/2≦f1=(A−B)/(|(A−B)|+|(C−D)|)

ML/2*|(A−B)|+MLi/2*|(C−D)|≦(A−B)

|(C−D)|≦(A−B)*2/ML−|(A−B)|

As such, in the simple determination expression, there are a lot of parts that can be previously calculated, at the time point of loading the burst A and B, without waiting for the load completion of the burst data C and D as in the head position determination expression. Therefore, it is possible to reduce a time from the completion of the load of the burst data C and D to the completion of the inhibit determination.

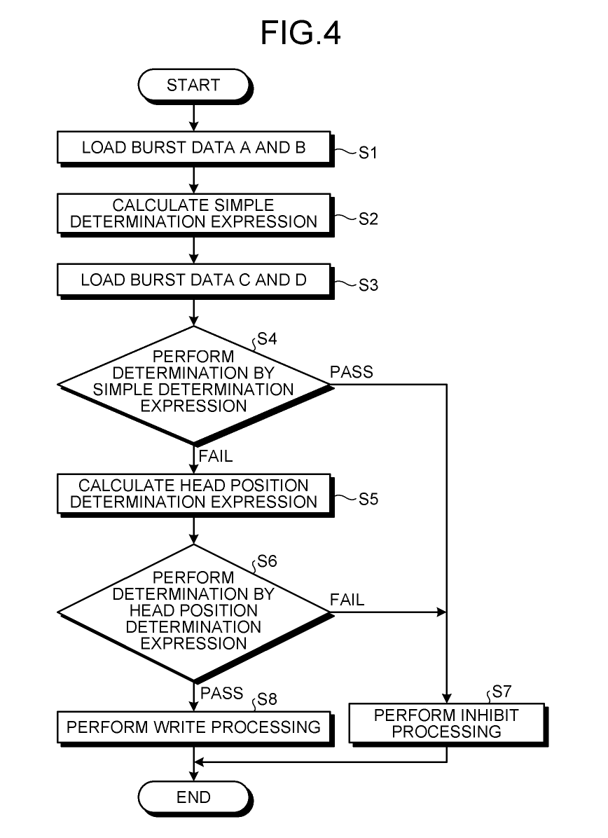

FIG. 4 is a flow chart illustrating a head position determining method in the magnetic disk device in FIG. 1.

In FIG. 4, when the burst data A and B are loaded (S1), the calculation of the right-hand sides of the simple determination expressions of Equations (2) and (3) is started (S2). When the burst data C and D are loaded (S3), the determination of Equations (2) and (3) is made (S4). When satisfying the condition of Equation (2) or (3), the inhibit processing is performed (S7).

On the other hand, when not satisfying the conditions of Equation (2) or (3), the calculation of the head position determination expression of Equation (1) is performed (S5). When the head position determination expression satisfies the upper/lower limit condition (S6), the write processing is performed (S8). On the other hand, when the head position determination expression does not satisfy the upper/lower limit condition (S6), the inhibit processing is performed (S7).

Also, in the method in FIG. 4, the method of starting the calculation of the head position determination expression after the determination by the simple determination expression is made has been described, but, after loading the burst data C and D, the calculation of the head position determination expression may be performed in parallel with the determination processing by the simple determination expression.

### Second Embodiment

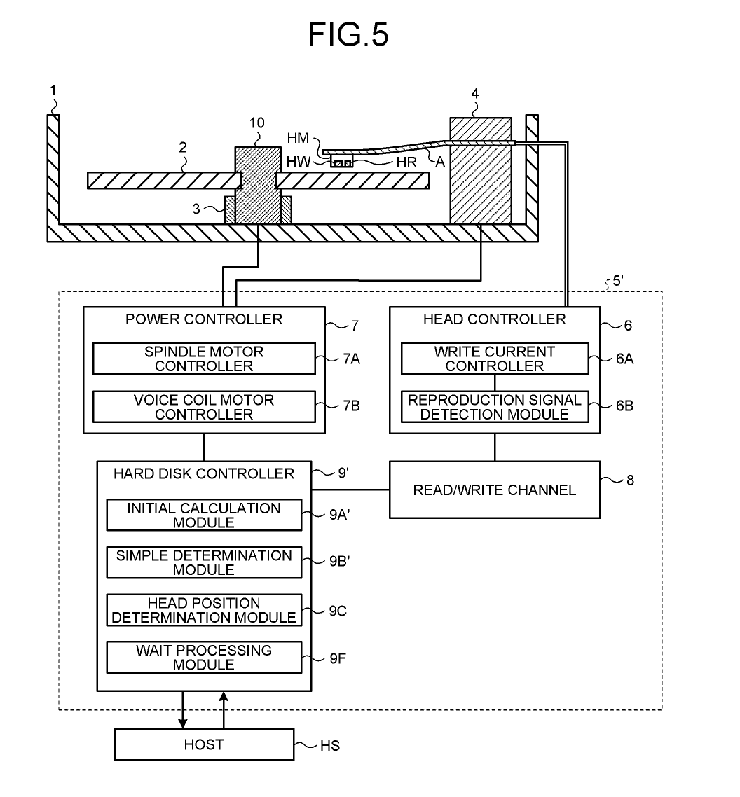

FIG. 5 is a block diagram illustrating a schematic configuration of a magnetic disk device according to a second embodiment.

In FIG. 5, in the magnetic disk device, a magnetic recording controller 5′ instead of the magnetic recording controller 5 in FIG. 1 is provided. In the magnetic recording controller 5′, a hard disk controller 9′ instead of the hard disk controller 9 in FIG. 1 is provided. In the hard disk controller 9′, an initial calculation module 9A′, a simple determination module 9B′, a head position determination module 9C, and a wait processing module 9F are provided. In a simple determination expression describing a magnitude relation between a first value calculated from the burst data A and B and a second value calculated from the burst data C and D, the initial calculation module 9A′ may start the calculation of the first value before the reading of the burst data C and D is completed. The simple determination module 9B′ may make a determination by the simple determination expression after the reading of the burst data C and D is completed. Also, in the simple determination expression, it may be determined whether the position of the magnetic head HM to the target track is always within an upper/lower limit range. When satisfying the condition of the simple determination expression, the wait processing module 9F may make the magnetic head HM wait on a magnetic disk 2, without performing the calculation of the head position determination expression. When not satisfying the condition of the simple determination expression, the wait processing module 9F may make the magnetic head HM wait on the magnetic disk 2, based on the calculation result of the head position determination expression.

Also, in the simple determination expression, it may be determined whether the position error amount PES of the magnetic head HM with respect to the target track always satisfies an upper/lower limit condition. The simple determination expression may be given by Equation (13) or (14), when it is assumed that LL is a lower limit, ML is an upper limit, and n is 2.

|C−D|≧(A−B)*2/ML−|A−B| and

|C−D|²≦(A−B)*|A−B|*2/LL−|A−B|² (13)

or

|C−D|≦(A−B)*2/LL−|A−B| and

|C−D|²≧(A−B)*|A−B|*2/ML−|A−B|² (14)

While the magnetic disk 2 is rotated by a spindle motor 10, a signal is read from the magnetic disk 2 through a read head HR and is detected by a reproduction signal detection module 6B. The signal detected by the reproduction signal detection module 6B is data-converted by a read/write channel 8 and is then transferred to the hard disk controller 9′. In the hard disk controller 9′, a tracking control of the magnetic head 2 is performed based on the burst data A, B, C and D included in the signal detected by the reproduction signal detection module 6B.

In this case, when a servo gate SG rises up, the burst data A, B, C and D are read from a servo area SS in order of A→B→C→D. When the burst data A and B are read, the right-hand sides of Equations (13) and (14) are calculated in the initial calculation module 9A′. In this case, since the burst data C and D are not included in the right-hand sides of Equations (13) and (14), the calculation of the right-hand sides of Equations (13) and (14) may be started before the reading of the burst data C and D is completed. When the reading of the burst data C and D is completed, the determination of Equations (13) and (14) is made in the simple determination module 9B′. In the case of satisfying the condition of Equation (13) or (14), the magnetic head HM waits on the magnetic disk 2 in the wait processing module 9F.

On the other hand, in the case of not satisfying the condition of Equation (13) or (14), when the reading of the burst data A, B, C and D is completed, the position error amount PES is calculated from Equation (1) in the head position determination module 9C. In the wait processing module 9F, the tracking control of the magnetic head HM is performed based on the position error amount PES, and the magnetic head HM waits on the magnetic disk 2.

Herein, since the calculation of the right-hand sides of Equations (13) and (14) may be started before the reading of the burst data C and D is completed, the determination of Equations (13) and (14) may be completed before the calculation of Equation (1) is completed. Therefore, in the case of satisfying the condition of Equation (13) or (14), it is possible to make the magnetic head HM wait on the magnetic disk 2, without performing the calculation of Equation (1). It is possible to reduce power consumption in an active idle mode in which the magnetic head HM waits on the magnetic disk 2, without any read and write in the data area DA.

Herein, as can be seen from FIG. 3, a maximum/minimum range of the head position determination expression of Equation (4) may be given by Equation (7). A range that surely satisfies the upper limit ML of an arbitrary position determination with respect to a range of f1>f2 is ML≧2*f1, and the range satisfies Equation (15) below.

f1≦ML/2 (15)

By applying Equation (5) to Equation (15), a first equation of Equation (13) may be derived.

That is, as described below, the first equation of Equation (13) may be obtained by applying Equation (5) to Equation (15), collecting C and D in the left-hand side, and collecting A and B in the right-hand side.

(A−B)/(|(A−B)|+|(C−D)|)=f1≦ML/2

(A−B)≦ML/2*(|(A−B)|+|(C−D)|)

|(C−D)|≧(A−B)*2/ML−(|(A−B)|)

Also, a range that surely satisfies the lower limit LL of an arbitrary position determination with respect to a range of f1>f2 is LL≧2*f2, and the range satisfies Equation (16) below.

LL/2≦f2 (16)

By applying Equation (6) to Equation (16), a second equation of Equation (13) may be derived.

LL/2≦f2=(A−B)*|(A−B)|/(|(A−B)|²+|(C−D)|²

LL/2*|(A−B)|²+LL/2*|(C−D)²≦(A−B)*|(A−B)|

|(C−D)|²≦(A−B)*|(A−B)|*2/LL−|(A−B)|²

Furthermore, a maximum/minimum range of the head position determination expression of Equation (4) may be given by Equation (10). A range that surely satisfies the lower limit LL of an arbitrary position determination with respect to a range of f1<f2 is f1*2≧LL, and the range satisfies Equation (17) below.

f1≧LL/2 (17)

By applying Equation (5) to Equation (17), a first equation of Equation (14) may be derived.

That is, as described below, the first equation of Equation (14) may be obtained by applying Equation (5) to Equation (17), collecting C and D in the left-hand side, and collecting A and B in the right-hand side.

(A−B)/(|(A−B)|+|(C−D)|)=f1≧LL/2

(A−B)≧LL/2*(|(A−B)|+|(C−D)|)

|(C−D)|≦(A−B)*2/LL−(|(A−B)|)

Also, a range that surely satisfies the upper limit ML of an arbitrary position determination with respect to a range of f1<f2 is 2*f2≦ML, and the range satisfies Equation (18) below.

LL/2≦f2 (18)

By applying Equation (6) to Equation (18), a second equation of Equation (14) may be derived.

ML/2≧f2=(A−B)*|(A−B)|/(|(A−B)|²+|(C−D)|²)

ML/2*|(A−B)|²+ML/2*|(C−D)|²≧(A−B)*|(A−B)|

|(C−D)|²≧(A−B)*|(A−B)|*2/ML−|(A−B)|²

As such, in the simple determination expression, there are a lot of parts that can be previously calculated, at the time point of loading the burst data A and B, without waiting for the load completion of the burst data C and D as in the head position determination expression. Therefore, in the case of an active idle mode in which the magnetic head HM waits on the magnetic disk 2, without any read and write in the data area DA, the calculation of the head position determination expression may be omitted. Thus, power consumption may be reduced.

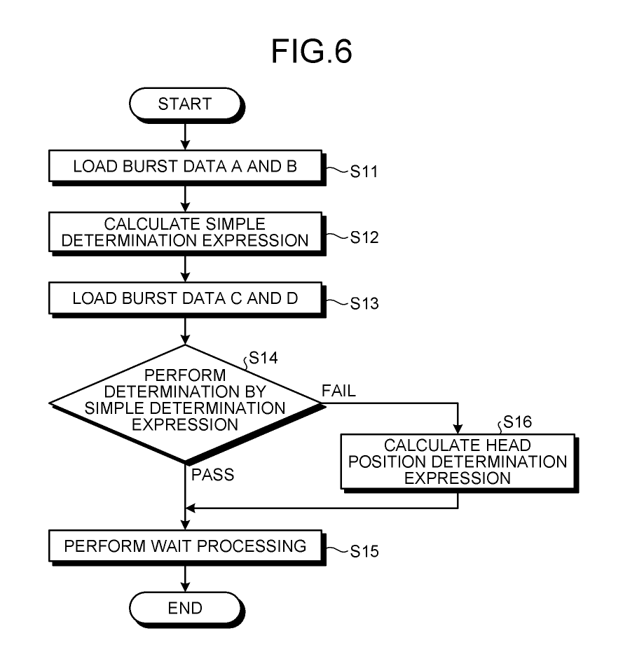

FIG. 6 is a flowchart illustrating a head position determining method in the magnetic disk device of FIG. 5.

In FIG. 6, when the burst data A and B are loaded (S11), the calculation of the right-hand sides of the simple determination expressions of Equations (13) and (14) is started (S12). When the burst data C and D are loaded (S13), the determination of Equations (13) and (14) is performed (S14). When satisfying the condition of Equation (13) or (14), the wait processing is performed (S15).

On the other hand, when not satisfying the condition of Equation (13) or (14), the calculation of the head position determination expression of Equation (1) is performed (S16). Then, the wait processing is performed based on the head position determination expression (S15).

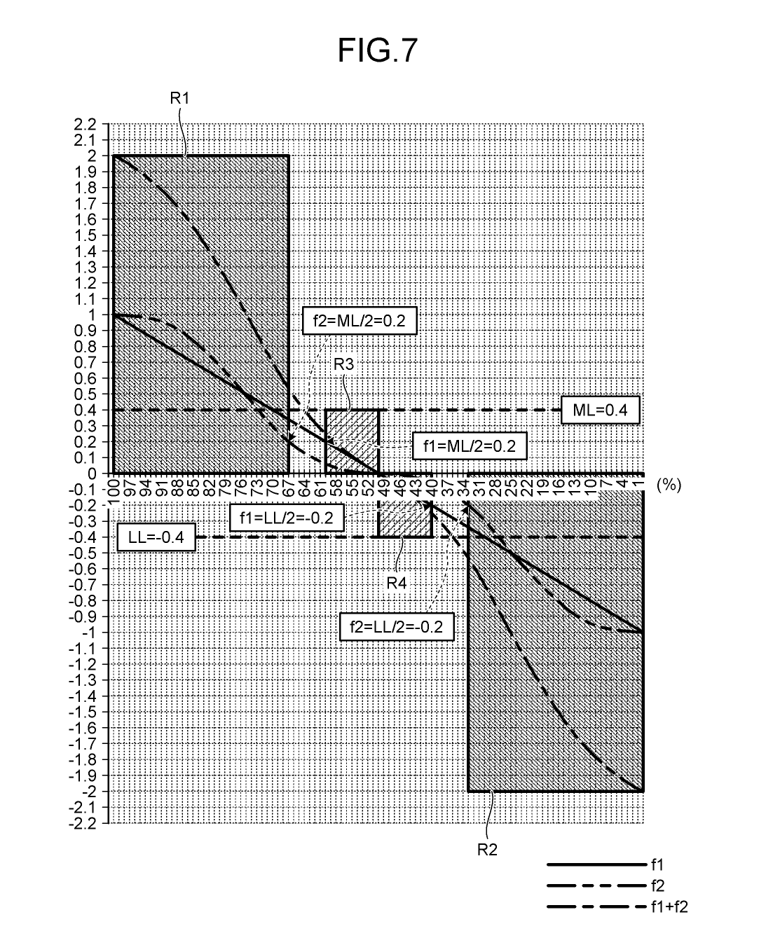

FIG. 7 is a diagram illustrating the inhibit determination ranges R1 and R2, which are described in the first embodiment, and the wait determination ranges R3 and R4, which are described in the second embodiment, according to the read levels of the burst data A, B, C and D of FIG. 2B. Also, FIG. 7 illustrates the case of the upper limit ML=0.4 and the lower limit LL=−0.4.

In FIG. 7, in the case of the upper limit ML=0.4 and the lower limit LL=−0.4, the inhibit determination range R1 is given by Equation (9), the inhibit determination range R2 is given by Equation (11), the wait determination range R3 is given by Equation (15), and the wait determination range R4 is given by Equation (17).

That is, the inhibit determination range R1 is f2≧0.2, the inhibit determination range R2 is f2≦−0.2, the wait determination range R3 is f1≦0.2, and the wait determination range R4 is f1≧−0.2.

In the inhibit determination ranges R1 and R2, the position of the magnetic head HM with respect to the target track is always out of the upper/lower limit range. Also, in the wait determination ranges R3 and R4, the position of the magnetic head HM with respect to the target track is always within the upper/lower limit range. Therefore, in the inhibit determination ranges R1 and R2, the magnetic disk device of FIG. 1 performs the inhibit processing, based on the simple determination expression. Also, in the wait determination ranges R3 and R4, the magnetic disk device of FIG. 5 performs the wait processing, based on the simple determination expression.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A magnetic disk device comprising:
a magnetic head;
a magnetic disk recorded with burst data for determining a position of the magnetic head on a track, based on a read result by the magnetic head;
an initial calculation module configured to, in a simple determination expression describing a magnitude relation between a first value calculated from a first half part of the burst data and a second value calculated from a second half part of the burst data, start a calculation of the first value before the reading of the second half part of the burst data is completed; and
a simple determination module configured to perform a determination by the simple determination expression after the reading of the second half part of the burst data is completed.

2. The magnetic disk device of claim 1, comprising:
a head position determination module configured to determine the position of the magnetic head, based on a head position determination expression calculated from the first half part and the second half part of the burst data;
an inhibit processing module configured to perform an inhibit processing to inhibit a write when satisfying a condition of the simple determination expression; and
a write processing module configured to perform a write processing, based on a calculation result of the head position determination expression, when not satisfying the condition of the simple determination expression.

3. The magnetic disk device of claim 2,
wherein the burst data comprises burst data A and B used for a center determination of the track, and burst data C and D used for an even/odd determination of the track,
the burst data A and B are the first half part of the burst data, and the burst data C and D are the second half part of the burst data,
the head position determination expression is given by
(A−B)/(|A−B|+|C−D|)+((A−B)*|A−B|)/(|A−B|²+|C−D|²), and
when it is assumed that LL is a lower limit value and ML is an upper limit value, the simple determination expression is given by

|C−D|≧(A−B)*2/LL−|A−B| and

|C−D|²≦(A−B)*|A−B|*2/ML−|A−B|²
or

|C−D|²≧(A−B)*|A−B|*2/LL−|A−B|² and

|C−D|≦(A−B)*2/ML−|A−B|.

4. The magnetic disk device of claim 1, comprising:
a head position determination module configured to determine the position of the magnetic head, based on a head position determination expression calculated from the first half part and the second half part of the burst data; and
a wait processing module configured to make the magnetic head wait on the magnetic disk, without performing the calculation of the head position determination expression, when satisfying the condition of the simple determination expression, and to make the magnetic head wait on the magnetic disk, based on the calculation result of the head position determination expression, when not satisfying the condition of the simple determination expression.

5. The magnetic disk device of claim 4,
wherein the burst data comprises burst data A and B used for a center determination of the track, and burst data C and D used for an even/odd determination of the track,
the burst data A and B are the first half part of the burst data, and the burst data C and D are the second half part of the burst data,
the head position determination expression is given by
(A−B)/(|A−B|+|C−D|)+((A−B)*|A−B|)/(|A−B|²+|C−D|²),and
when it is assumed that LL is a lower limit value and ML is an upper limit value, the simple determination expression is given by

|C−D|≧(A−B)*2/ML−|A−B| and

|C−D|²≦(A−B)*|A−B|*2/LL−|A−B|²
or

|C−D|≦(A−B)*2/LL−|A−B| and
C−D|²≧(A−B)*|A−B|*2/ML−|A−B|².

6. A magnetic disk controlling apparatus comprising:
an initial calculation module configured to, in a simple determination expression describing a magnitude relation between a first value calculated from a first half part of burst data, which is capable of determining a position of a magnetic head on a magnetic disk for each track, and a second value calculated from a second half part of the burst data, start a calculation of the first value before the reading of the second half part of the burst data is completed; and
a simple determination module configured to perform a determination by the simple determination expression after the reading of the second half part of the burst data is completed.

7. The magnetic disk controlling apparatus of claim 6, comprising:
a head position determination module configured to determine the position of the magnetic head, based on a head position determination expression calculated from the first half part and the second half part of the burst data;
an inhibit processing module configured to perform an inhibit processing to inhibit a write when satisfying a condition of the simple determination expression; and
a write processing module configured to perform a write processing, based on a calculation result of the head position determination expression, when not satisfying the condition of the simple determination expression.

8. The magnetic disk controlling apparatus of claim 7,
wherein the burst data comprises burst data A and B used for a center determination of the track, and burst data C and D used for an even/odd determination of the track,
the burst data A and B are the first half part of the burst data, and the burst data C and D are the second half part of the burst data,
the head position determination expression is given by
(A−B)/(|A−B|+|C−D|)+((A−B)*|A−B|)/(|A−B|²+|C−D|²), and
when it is assumed that LL is a lower limit value and ML is an upper limit value, the simple determination expression is given by

|C−D|≧(A−B)*2/LL−|A−B| and

|C−D|²≦(A−B)*|A−B|*2/ML−|A−B|²
or

|C−D|²≧(A−B)*|A−B|*2/LL−|A−B|² and

|C−D|≦(A−B)*2/ML−|A−B|.

9. The magnetic disk controlling apparatus of claim 6, comprising:
a head position determination module configured to determine the position of the magnetic head, based on a head position determination expression calculated from the first half part and the second half part of the burst data; and
a wait processing module configured to make the magnetic head wait on the magnetic disk, without performing the calculation of the head position determination expression, when satisfying the condition of the simple determination expression, and to make the magnetic head wait on the magnetic disk, based on the calculation result of the head position determination expression, when not satisfying the condition of the simple determination expression.

10. The magnetic disk controlling apparatus of claim 9,
wherein the burst data comprises burst data A and B used for a center determination of the track, and burst data C and D used for an even/odd determination of the track,
the burst data A and B are the first half part of the burst data, and the burst data C and D are the second half part of the burst data,
the head position determination expression is given by
(A−B)/(|A−B|+|C−D|)+((A−B)*|A−B|)/(|A−B|²+|C−D|²), and
when it is assumed that LL is a lower limit value and ML is an upper limit value, the simple determination expression is given by

|C−D|≧(A−B)*2/ML−|A−B| and

|C−D|²≦(A−B)*|A−B|*2/LL−|A−B|²
or

|C−D|≦(A−B)*2/LL−|A−B| and

|C−D|²≧(A−B)*|A−B|*2/ML−|A−B|².

11. A head position determining method in a magnetic disk device having a magnetic disk and a magnetic head, comprising:
in a simple determination expression describing a magnitude relation between a first value calculated from a first half part of burst data, which is capable of determining a position of a magnetic head on a magnetic disk for each track, and a second value calculated from a second half part of the burst data, starting a calculation of the first value before the reading of the second half part of the burst data is completed; and
performing a determination by the simple determination expression after the reading of the second half part of the burst data is completed.

12. The head position determining method of claim 11, comprising:
determining the position of the magnetic head, based on a head position determination expression calculated from the first half part and the second half part of the burst data;
performing an inhibit processing to inhibit a write when satisfying a condition of the simple determination expression; and
performing a write processing, based on a calculation result of the head position determination expression, when not satisfying the condition of the simple determination expression.

13. The head position determining method of claim 12,
wherein the burst data comprises burst data A and B used for a center determination of the track, and burst data C and D used for an even/odd determination of the track,
the burst data A and B are the first half part of the burst data, and the burst data C and D are the second half part of the burst data,
the head position determination expression is given by
(A−B)/(|A−B|+|C−D|)+((A−B)*|A−B|)/(|A−B|²+|C−D|²),and
when it is assumed that LL is a lower limit value and ML is an upper limit value, the simple determination expression is given by

|C−D|≧(A−B)*2/LL−|A−B| and

|C−D|²≦(A−B)*|A−B|*2/ML−|A−B|²
or

|C−D|²≧(A−B)*|A−B|*2/LL−|A−B|² and

|C−D|≦(A−B)*2/ML−|A−B|.

14. The head position determining method of claim 11, comprising:
determining the position of the magnetic head, based on a head position determination expression calculated from the first half part and the second half part of the burst data; and
when satisfying the condition of the simple determination expression, making the magnetic head wait on the magnetic disk, without performing the calculation of the head position determination expression, and when not satisfying the condition of the simple determination expression, making the magnetic head wait on the magnetic disk, based on the calculation result of the head position determination expression.

15. The head position determining method of claim 14,
wherein the burst data comprises burst data A and B used for a center determination of the track, and burst data C and D used for an even/odd determination of the track,
the burst data A and B are the first half part of the burst data, and the burst data C and D are the second half part of the burst data,
the head position determination expression is given by
(A−B)/(|A−B|+|C−D|)+((A−B)*|A−B|)/(|A−B|²+|C−D|²),and
when it is assumed that LL is a lower limit value and ML is an upper limit value, the simple determination expression is given by

|C−D|≧(A−B)*2/ML−|A−B| and

|C−D|²≦(A−B)*|A−B|*2/LL−|A−B|²
or

|C−D|≦(A−B)*2/LL−|A−B| and
C−D|²≧(A−B)*|A−B|*2/ML−|A−B|².
